(19) United States
(12) Patent Application Publication
(10) Pub. No.: US 2008/0295933 A1
(43) Pub. Date: Dec. 4, 2008

(54) Tire Tread Support Element Comprising A Recess For An Electronic Module, And An Electronic Module Adapted Thereto

(75) Inventors: Jean-Charles Lacour, Clermont-Ferrand (FR); Mickael Lion, Clermont-Ferrand (FR); Johathan Champredonde, Manzat (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (SW)

(21) Appl. No.: 11/996,212

(22) PCT Filed: Jul. 19, 2006
(86) PCT No.: PCT/EP2006/064402

§ 371 Date: Jun. 10, 2008

(30) Foreign Application Priority Data
Jul. 19, 2005 (FR) 0507789

(51) Int. Cl. B60C 19/00

(52) U.S. Cl. 152/152.1

(57) ABSTRACT

Insert for supporting the tread of a tire and intended to be positioned around the bearing surface of a wheel and including a housing for an electronic module opening radially internally relative to the insert, characterized in that the insert comprises a support part intended to bear the load of the tire under runflat conditions, and an axially adjacent locking part intended to lock one of the beads of the tire onto its wheel seat and in that the housing is positioned in the bead locking part.

### BACKGROUND OF THE INVENTION

1. Field of the Invention

The present invention relates to a tread support insert comprising a housing for an electronic module and to an appropriate electronic module.

2. Description of Related Art

Tread support inserts comprising housings for electronic modules intended, in particular, to monitor tire pressure, are already known in the prior art.

Document EP 0 775 601 B1 discloses an insert for supporting the tread of a tire and intended to be positioned around the bearing surface of a wheel and comprising a housing for an electronic module opening radially internally relative to the insert, in which the housing is a circumferential groove. The electronic module is held in place by the clamping of the insert against the rim and is protected by two lips of the circumferential groove.

### SUMMARY OF THE INVENTION

The subject of the invention is a tread support insert, characterized in that the housing of the electronic module has a more or less parallelepipedal shape and comprises means for holding the electronic module in place, which comprises a number of wedges of more or less triangular cross section positioned on the lateral walls of the housing. As used herein, more or less means about, approximate or approximately.

As a preference, the wedges positioned on the lateral walls of the housing have a wall intended to come into contact with the electronic module which has a slight undercut.

This undercut allows the electronic module to be locked in position without preventing it from being able to be inserted into the housing.

Advantageously, the housing has a bottom with a set of bottom ribs.

These bottom ribs have the advantage of holding the electronic module away from the bottom of the housing and thus forming a layer of air in the bottom of the housing between the insert and the electronic module; this layer of air may act as a thermal barrier to limit the transmission of heat energy between the insert and the module under runflat conditions. These ribs also, in conjunction with the wedges positioned on the lateral walls, allow a constant flow of air all around the electronic module.

The bottom ribs may be positioned parallel to one another and directed along the shortest dimension of the bottom of the housing. This has the advantage of facilitating fluidic continuity between the layers of air separating the various walls of the housing and of the electronic module and the tire cavity defined by the rim and the tire.

The bottom of the housing also preferably comprises at least one radial opening intended to place the housing in fluidic communication with the internal cavity of the tire. These openings or ducts play a part in evening out the temperature all around the electronic module and its housing.

Another subject of the invention is an insert similar to the one in document EP 0 775 601 B1, in which, with the insert comprising a sole with a set of more or less inextensible reinforcements directed more or less circumferentially, none of the said circumferential reinforcements lies axially in the region of the housing. The circumferential reinforcements are advantageously positioned axially on each side of the housing.

As a preference, the insert comprises a support part intended to bear the load of the tire under runflat conditions, and an axially adjacent locking part intended to lock one of the beads of the tire onto its wheel seat and the housing is positioned in the bead locking part. Positioning the electronic module in this part of the insert which is not intended to bear the load but is intended to lock a tire bead onto its seat, ensures that the mechanical stresses liable to be transmitted to the electronic module in the event of a knock or under runflat conditions, are very much minimized. This is an important factor in electronic module life.

As the locking part plays practically no part in bearing the load under runflat conditions, its mass is far lower than that of the load bearing part and a markedly lower number of circumferential reinforcements is needed to give the insert good resistance to centrifugal effects in this part.

The insert according to the invention can be used with a two-part wheel like the one described in application EP 0 363 639. It is preferably intended to be slipped around a wheel rim comprising a first rim seat of a maximum diameter Φ_{S1max}, and a second rim seat of a maximum diameter Φ_{S2max} greater than the maximum diameter of the said first seat Φ_{S1max}, the second seat being extended axially towards the first seat by a circumferential groove and a bearing surface, the outside diameter of which is more or less equal to the maximum diameter of the first seat Φ_{S1max}. This insert is such that the support part of the insert is designed to be positioned around the bearing surface and the locking part is designed to be positioned radially externally relative to the circumferential groove.

Likewise, the housing for the electronic module is intended to be positioned radially externally relative to the circumferential groove. This improves the protection afforded to the electronic module in the event of a knock or under runflat conditions.

As a preference, with the second seat being extended towards the first seat by a sidewall of the circumferential groove, the locking part of the insert is designed to bear against the sidewall of the groove. Accordingly, in a highly preferred embodiment, the wheel comprises a rim and a disc connected to the rim on the said second seat side.

Advantageously, when a tire having a first bead and a second bead is intended to be mounted on the first and second seats of the rim, the second bead having circumferentially-directed reinforcements of outside diameter Φ_{T2max}, the housing falls within a cylinder of revolution of diameter Φ_{Lmax} smaller than the outside diameter Φ_{T2max}. That further enhances the mechanical protection afforded to the electronic module in use. This is because the bottom of the module housing is protected against knocks by the larger-diameter seat of the rim and also by the reinforcements, such as bead wires, which hold the bead firmly on its seat during operation because these reinforcements have an outside diameter greater than that of the cylinder of revolution in which the housing lies.

Another subject of the invention is an electronic module intended to be positioned in a housing of a tire tread support insert. This electronic module comprises in particular an electronic component support (a PCB), a pressure sensor, a transmitter and a transmission antenna, and is characterized in that it has a more or less parallelepipedal shape with an internal face and an external face and in that the electronic component support is positioned closest to the internal face and in that the transmission antenna is positioned closest to the external face.

Organizing the constituent parts of the electronic module in this way makes it possible to greatly reduce the overall volume of the module while at the same time achieving good electromagnetic operation.

Advantageously, the antenna is a U-shaped wire antenna and is positioned in a plane parallel to the plane defined by the component support (the PCB) and more or less follows the edges of the electronic module. The area occupied by the U is therefore at a maximum so as to emit a maximum number of field lines, and is also as far away as possible from the ground plane which corresponds to the component support (the PCB) in order to limit the capacitive coupling with the PCB and improve its performance. This antenna is mechanically attached to the component support by at least one end.

The antenna comprises a conducting wire and has tuning capacitors to make it resonate at a UHF frequency, for example of the order of 315 MHz. The fact of using a “wire” antenna rather than a metal surface has the advantage of not blocking out any low-frequency communications that may be needed in order to transmit specific instructions to the electronic module, particularly in order to ask it to emit more quickly, etc., using initiators positioned near the wheel-tire assembly, for example in the vehicle wheelarches.

As a preference, the cross sections of the electronic module normal to the external and internal faces are trapezoidal, and the face with the largest surface area is the external face intended to be positioned radially externally relative to the axis of the insert. The internal face preferably has a concavity tailored to the internal profile of the insert. This concavity also corresponds to the internal profile of the wheel and appreciably improves the mechanical strength of the electronic module in the event of knocks originating out of potholes or runflat conditions. The lateral walls of the module therefore have an angle of inclination tailored to suit that of the lateral retaining wedges of the housing. Collaboration between the two allows the electronic module to be held very firmly in place in its housing irrespective of the running conditions.

Advantageously, the pressure sensor is in fluidic communication with the outside of the module via a passageway opening into the external face. This external face is intended to be positioned against the bottom of the housing. The bottom ribs collaborate with the wedges of the lateral walls and the adjacent circumferential groove in order to ensure fluidic continuity and good pressure and temperature measurements as appropriate.

### BRIEF DESCRIPTION OF THE DRAWINGS

Other features and advantages of the invention will emerge from the description given hereinafter with reference to the attached drawings, which, by way of nonlimiting examples, show some embodiments of the subject matter of the invention:

FIG. 1 shows a view in partial meridian section of an exemplary insert, sensor, rim and tire assembly according to the invention;

FIG. 2 shows a partial view of an exemplary insert according to the invention, illustrating the position of the housing;

FIG. 3 shows a view in partial meridian section of an insert illustrating the support partitions of the insert of FIG. 1;

FIG. 4 shows a view in meridian section of the housing of the insert of FIG. 1;

FIG. 5 is similar to FIG. 4, including the electronic module;

FIGS. 6 and 7 show schematic views of an exemplary electronic module according to the invention illustrating the position and shape of the main electronic components; and

FIG. 8 is a partial view in longitudinal section of an exemplary insert according to the invention including the electronic module.

### DETAILED DESCRIPTION OF THE INVENTION

As used herein, meridian or axial plane is to be understood to mean any plane passing through the axis A of the wheel and of the rim and a longitudinal or circumferential section is to be understood to mean a section on a plane perpendicular to the axis of rotation A of the wheel, the rim and the insert.

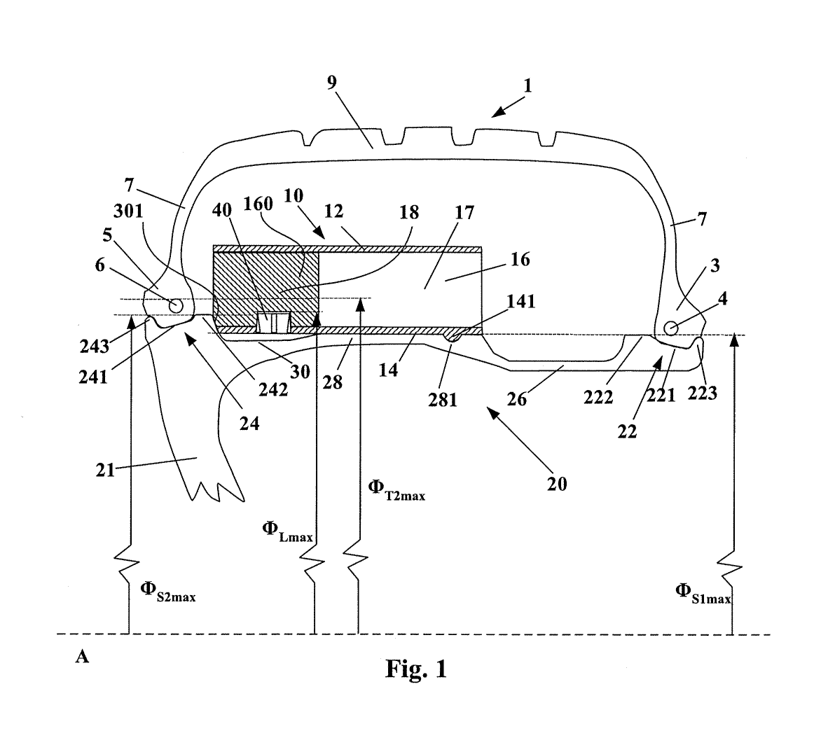

FIG. 1 shows, viewed in partial meridian or axial section, an insert 10, rim 20 and tire 1 assembly according to the invention. The rim 20 forms, with a disc 21, a one-piece wheel. The disc may equally be manufactured independently of the rim and joined thereto thereafter. The rim 20 comprises a first seat 22 and a second seat 24 which seats are intended to act as bearing surfaces for the first 3 and second 5 beads of the tire 1.

The first seat 22 has a frustoconical bottom 221 locally coinciding with a cone of revolution coaxial with the rim and open towards the second seat 24, a safety hump 222 extending the bottom 221 of the first seat 22 towards the second seat 24, and an external lip 223 extending the bottom 221 of the first seat on the opposite side to the second seat 24. The maximum diameter of the first seat 22 is Φ_{S1max}. This diameter corresponds to the maximum diameter of the safety hump 222.

The second seat 24 comprises a frustoconical bottom 241 that locally coincides with a cone of revolution coaxial with the rim and open towards the first seat 22, a safety hump 242 extending the bottom 241 of the second seat 24 towards the first seat 22 and an external lip 243 extending the bottom 241 of the second seat on the opposite side to the first seat 22. The maximum diameter of the second seat 24 is Φ_{S2max}. This diameter corresponds to the maximum diameter of the safety hump 242.

The maximum diameter of the second seat is greater than that of the first seat. In the example depicted, the order of magnitude of the difference between the maximum diameters Φ_{S2max}−Φ_{S1max} is of the order of 20 mm. The difference between the minimum radii of the two seats is therefore of the order of 10 mm.

In the first seat 22 towards the second seat 24 there are, in succession, a circumferential groove 26, a bearing surface 28 and a second circumferential groove 30. The second circumferential groove 30 acts as a mounting groove for the second seat 24. The groove 30 has a sidewall 301 adjacent to the safety hump 242. On the bearing surface 28 there is a circumferential slot 281. The outside diameter of the bearing surface 28 corresponds more or less to the maximum diameter of the first seat 22 so as to allow the insert 10 to be slipped onto this bearing surface 28 having negotiated the first seat 22.

The tire 1 comprises two beads 3 and 5 intended to bear against the seats 22 and 24 of the rim 20, two sidewalls 7 and a tread 9. Each bead has annular reinforcements directed more or less circumferentially and which are practically inextensible. These reinforcements, such as bead wires 4 and 6, are intended, in service to hold the beads on the rim seats. The bead wire 6 of the bead 5 of the second seat 24 has an outside diameter Φ_{T2max}.

The insert 10 essentially comprises:
a more or less cylindrical crown region 12 intended to come into contact with the tread 9 of the tire 1 in the event of a loss of pressure, but leaving clearance with respect to this tire at nominal pressure,
a more or less cylindrical sole 14 intended to fit around the rim 20, this sole comprising a plurality of wedges 141 positioned circumferentially, of more or less semi-cylindrical cross section intended to collaborate with the slot 281 to lock the insert 10 in position on the bearing surface 28 of the rim 20, and
an annular body 16 connecting the sole 14 and the crown region 12, this body comprising a collection of Y-shaped partitions 160 more or less radially connecting the sole and the crown region and directed more or less axially from one side of the insert to the other.

This insert comprises a housing 40 which opens radially internally relative to the insert and which is intended to house an electronic module 50. An electronic module such as this forms part of a tire pressure monitoring system like the one disclosed in document WO 94/20317. The electronic module periodically measures the pressure and temperature of the air in the cavity formed by the tire and the rim and also periodically sends the values of these measurements to a central processing unit where these values are analysed and processed.

The sole 14 comprises circumferentially-directed reinforcements such as steel threads or high-modulus textile reinforcements such as aramid. Their function is to oppose the centrifugal forces experienced by the insert during high-speed running so as to allow the insert to remain bearing against the bearing surface without shifting circumferentially. These reinforcements, which have not been depicted in the figure, are positioned axially on each side of the housing 40.

FIG. 1 shows the mounted tire 1, insert 10 and rim 20 assembly. It can be seen that the insert is positioned around the bearing surface 28 of the rim 20 and extends axially radially externally relative to the groove 30 until it comes to bear against the sidewall 301 of this groove 30. The part of the insert positioned around the bearing surface 28 is the so-called “support” part; it is this support part 17 which mainly bears the load under runflat conditions with contact between the tire tread and the crown region of the insert. The part of the insert positioned around the groove 30 is termed the “locking” part. The function of this locking part 18 is to shelter the housing 40 and lock the second bead 5 of the tire 1 in position on its seat 24. This anti-unseating function of the locking part 18 of the insert supplements the similar action of the safety hump 242 of the second seat 24.

It should be noted that the housing falls within a cylinder of revolution of diameter Φ_{Lmax}. This diameter is greater than that of the adjacent seat 24 but is smaller than that of the bead wire 6 of the bead 5 of the tire 1. As a result, in the event of a particularly violent knock, the electronic module will be protected by the bead of the tire.

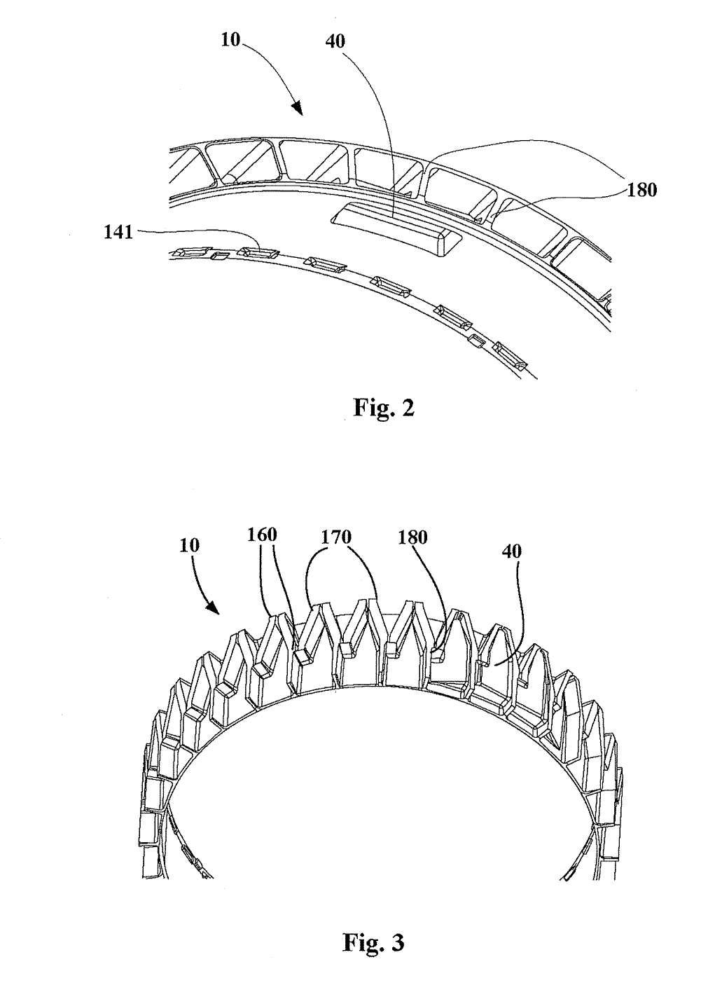

FIG. 2 shows a view of the radially internal wall of the insert including the housing 40. This view shows the wedges 141 that lock the insert against the bearing surface 28 and the ends of the partitions 160 of the annular body 16 on the locking part 18 side.

FIG. 3 shows a view of the insert in which the crown region 12 and the radially external part of the partitions 160 have been removed. The partitions 160, in the example depicted, are in the overall shape of a Y. The partitions 170 in the support part 17 correspond to the V-shaped part of the Y. These partitions 170 are slightly inclined relative to the axial direction. The partitions 180 in the locking part 18 correspond to the I-shaped part of the Y. They are directed more or less axially. The thickness of the partitions 170 is appreciably greater than that of the partitions 180 because of their load-bearing function. It can be seen from these two FIGS. 2 and 3 that the housing 40 runs circumferentially over two Y-patterns.

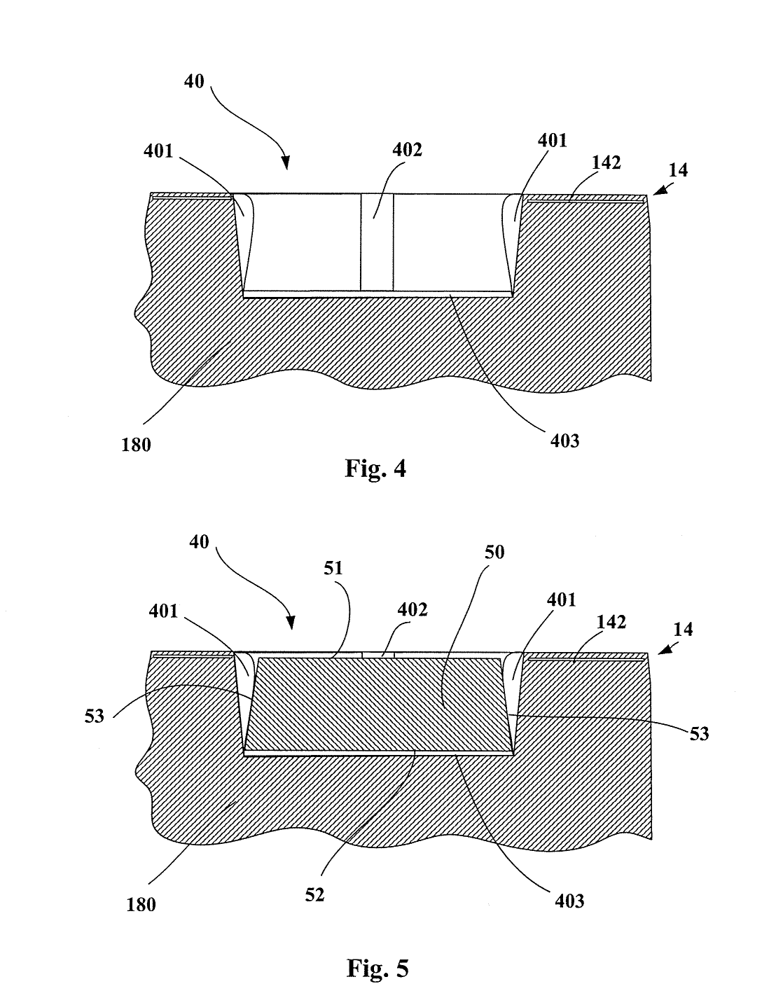

FIG. 4 shows an axial section similar to that of FIG. 1 but on a larger scale. This figure is centered on the housing 40. The lateral walls of the housing 40 have a slight undercut relative to the radial direction to make the insert easier to remove from the mould. The locking wedges 401 positioned on the two longest lateral walls can be seen. These wedges have a more or less triangular cross section which a slight undercut gives. This undercut has the function of allowing the electronic module 50 to be locked in position. Also visible are the wedges 402 positioned on the shortest lateral walls of the housing. These wedges have the same geometry and the same function as the wedges 401. Also visible is a wedge 403 positioned at the surface at the bottom of the housing 40. This wedge is oriented parallel to the axis of the insert. Its function is to keep the module away from the bottom of the housing in order to create a layer of air which can circulate freely by virtue of the lateral wedges. This layer of air acts as a thermal barrier protecting the electronic module in use. It also allows the pressure sensor positioned in the electronic module to be in fluidic communication with the cavity created by the tire and the rim so that correct tire-inflation-pressure measurements can be taken.

The circumferentially-directed reinforcing threads 142 are depicted schematically in the sole 14 of the insert 10. These threads are positioned on each side of the housing 40. The section has been taken in line with a partition 180 of the locking part 18.

FIG. 5 is identical to FIG. 4 simply with the module depicted in the locked position. The module 50 has a trapezoidal cross section in axial section and in circumferential section, that is to say in a plane perpendicular to the axial plane passing through the housing 40. The smallest-area wall 51 of the electronic module is positioned radially internally relative to the axis of the insert, that is to say positioned facing the groove 30 of the rim. The largest-area wall 52 of the electronic module is positioned radially externally and is thus in contact with the wedges 403 positioned in the bottom of the housing. The lateral walls 53 have a slight undercut tailored to suit that of the wedges 401 and 402 in order to lock the electronic module effectively in use.

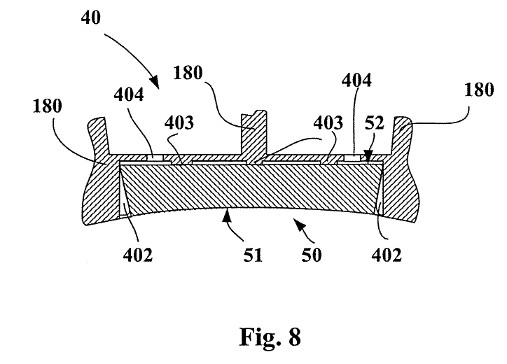

FIG. 8 shows a longitudinal section of the insert at the region of the housing 40 with the electronic module 50 in the locked position. This FIG. 8 shows that the housing 40 extends axially over a distance corresponding to two Y-patterns. Three partitions 180 can be seen in section. The housing 40 comprises three bottom wedges 403 directed axially and two lateral wedges 402. Also visible are two holes 404 positioned in the bottom wall of the housing in order to place the housing and the internal cavity of the tire in fluidic communication with each other. This figure also shows that the internal wall of the module 50 has a concavity tailored to the concavity of the insert 10. This concavity appreciably improves the fatigue strength and the resistance to knocks of the electronic module.

The thicknesses of the partitions 170 and 180 are engineered so that, near the azimuth of the housing 40, there is no change in the radial rigidity of the tread support insert. Likewise, at 180° from the housing 40, the geometry of the insert is modified to balance the static imbalance of the support insert.

The tread support insert may be made of elastomeric materials, particularly of rubbery materials but also of polyurethane elastomer PU or thermoplastic elastomer TPE. In any event, the precise geometry of the electronic module locking wedges will be engineered to allow ease of fitting and removal of the module while at the same time maintaining excellent locking in position in use. In particular, the axial and circumferential widths of the wedges can be adapted to suit the modulus of the raw material of which the insert is made.

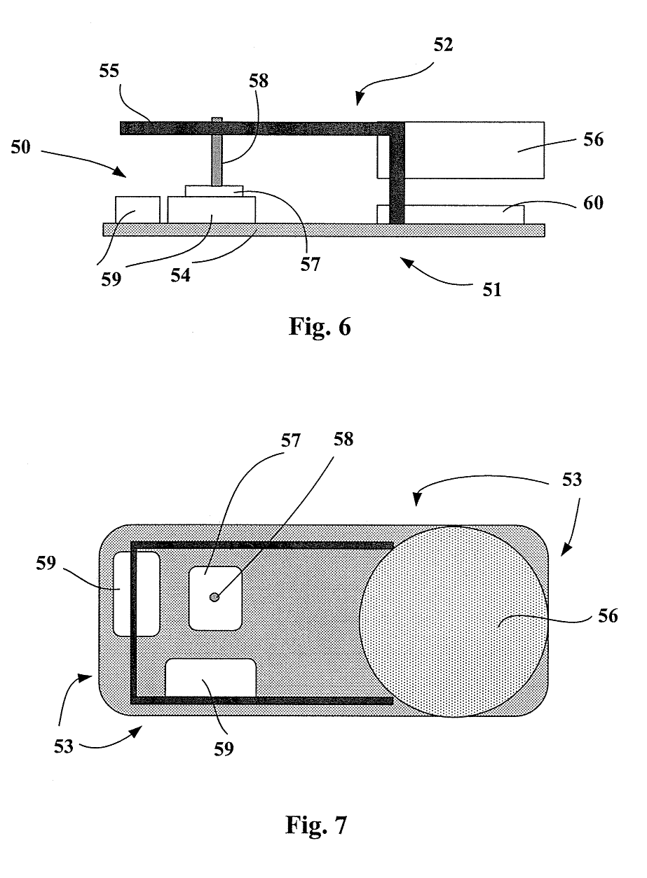

FIGS. 6 and 7 depict, in a side view and a view from above, an electronic module according to the invention. These two views show the main electronic elements that make up the electronic module before they are incorporated into a packaging such as a casing or a potting resin.

The electronic module 50 comprises an electronic component support or PCB 54, a UHF transmission antenna 55, a pressure sensor 57 with a cylindrical passageway 58 intended to place the sensitive part of the sensor 57 in fluidic communication with the tire cavity defined by the tire and the rim, a battery 56, two LF receiving antennas 59, and several other components 60 such as the HF transmitter and a microprocessor for processing the data and the signals received and transmitted.

The electronic component support or PCB 54 is positioned more or less at the internal face of the module which is intended to be positioned on the radially internal side of the housing 40 of the support insert 10. The UHF transmission antenna is positioned more or less at the external surface 52 of the module 50. This external face is intended to be positioned on the radially external side of the housing 40 of the supporting insert 10.

The transmission antenna 55 is a U-shaped wire antenna connected mechanically to the PCB by its ends. This antenna for the most part lies in the plane of the external face, the plane radially furthest from the plane defined by the ground plane of the module consisting of the PCB. This limits the capacitive coupling between the two and thus improves antenna performance. The area occupied by the U is practically at a maximum in order to pick up a maximum of field lines.

The antenna is made of a conducting wire, such as an individual copper wire. It is connected to the circuit of the module via appropriate tuning capacitors in order to make it resonate at a frequency of the order of 315 MHz, for example. The benefit of a wire antenna rather than a patch antenna is that it is the perimeter of the surface of the antenna that is used to emit UHF waves, thus not blocking low-frequency communications and allowing the passageway 58 to be led through.

It should be noted that the insert and module assembly according to the invention has been subjected to prolonged runflat testing and to kerbing and pothole testing and that, on completion of this testing, the electronic module was still in good working order.

The invention is not restricted to the examples described and depicted and various modifications can be made thereto without departing from its scope which is limited only by the claims which follow.

What is claimed is:

1. An insert for supporting the tread of a tire, said insert being positioned around a bearing surface of a rim, wherein the insert comprises
(1) a housing for an electronic module opening radially internally relative to said insert, wherein said housing has an approximate parallelepipedal shape, and
(2) means for holding said electronic module in place, said means comprising a number of wedges of approximate triangular cross section positioned on lateral walls of said housing.

2. The insert according to claim 1, wherein said wedges have a wall for coming into contact with said electronic module with a slight undercut.

3. The insert according to claim 1 or 2, wherein said housing has a bottom with a set of bottom ribs.

4. The insert according to claim 3, wherein said bottom ribs are positioned parallel to one another and are directed along a shortest dimension of said bottom of said housing.

5. The insert according to claim 3 or 4, wherein the bottom of the housing comprises at least one radial opening for placing the housing in fluidic communication with the internal cavity of the tire.

6. An insert for supporting the tread of a tire wherein the insert is positioned around the bearing surface of a rim and wherein the insert comprises
(1) a housing for an electronic module opening radially internally relative to said insert, and
(2) a sole having a set of more or less inextensible reinforcements directed approximately circumferentially, wherein none of said circumferential reinforcements lies axially in the region of said housing.

7. The insert according to claim 6, wherein said circumferential reinforcements are positioned axially on each side of said housing.

8. The insert according to claim 1, 2, 3 4, 5, 6 or 7, wherein said insert further comprises
(1) a support part for bearing the load of said tire under runflat conditions, and
(2) an axially adjacent locking part for locking one of the beads of said tire onto its wheel seat, wherein the housing is positioned in the bead locking part.

9. The insert according to claim 8, for slipping around a wheel rim comprising
(1) a first rim seat of a maximum diameter Φ_{S1max}, and
(2) a second rim seat of a maximum diameter Φ_{S2max} greater than the maximum diameter of the said first seat Φ_{S1max}, said second seat being extended axially towards the first seat by a circumferential groove and a bearing surface, wherein the outside diameter of the bearing surface is approximately equal to the maximum diameter of the first seat Φ_{S1max}, and wherein said support part of said insert is designed to be positioned around said bearing surface and said locking part is designed to be positioned radially externally relative to said circumferential groove.

10. The insert according to claim 9, wherein said housing is positioned radially externally relative to the circumferential groove.

11. The insert according to claim 9 or 10, wherein said second seat is extended towards the first seat by a sidewall of said circumferential groove, and wherein said locking part of said insert is designed to bear against said sidewall of said groove.

12. The insert according to claim 9, 10 or 11, wherein said wheel comprises a rim and a disc and wherein said disc is connected to said rim on said second seat side.

13. The insert according to claim 12, further comprising a tire having a first bead and a second bead wherein the tire is mounted on the said first and second seats of said rim, wherein said second bead of the tire has circumferentially-directed reinforcements of outside diameter Φ_{T2max}, and wherein said housing falls within a cylinder of revolution of diameter Φ_{Lmax} smaller than said outside diameter Φ_{T2max}.

14. The insert according to claim 13, wherein said circumferential reinforcements of said second bead are a bead wire.

15. An electronic module to be positioned in a housing of an insert according to claim 4, 5, 6, 7, 8, 9, 10, 11, 12 13 or 14, said electronic module comprising
(1) an electronic component support,
(2) a pressure sensor,
(3) a transmitter, and
(4) a transmission antenna,
wherein the electronic module has approximately a parallelepipedal shape with an internal face and an external face wherein the electronic component support is positioned closest to the internal face and wherein the transmission antenna is positioned closest to the external face.

16. The electronic module according to claim 15, wherein said antenna is a U-shaped wire antenna and wherein said antenna approximately follows the edges of said external face.

17. The electronic module according to claim 16, wherein said antenna is mechanically attached to said component support by at least one end.

18. The electronic module (50) according to claim 15, 16 or 17, wherein the cross sections of said module normal to the said external and internal faces are trapezoidal.

19. The electronic module according to claim 18, wherein a face with the largest surface area is the external face being positioned radially externally relative to the axis A of said insert.

20. The electronic module according to claim 15, 16, 17, 18 or 19, wherein the internal face has a concave shape tailored to an internal profile of the insert.

21. The electronic module according to claim 15, 16, 17, 18, 19 or 20, wherein said pressure sensor is in fluidic communication with the outside of the said module via a passageway opening into the said external face.
